(19) United States
(12) Patent Application Publication
(10) Pub. No.: US 2011/0189505 A1
(43) Pub. Date: Aug. 4, 2011

(54) METHOD FOR MANUFACTURING GLASS SUBSTRATE FOR MAGNETIC RECORDING MEDIUM

(75) Inventors: Takeaki ONO, Tokyo (JP); Noriaki Shimodaira, Tokyo (JP)

(73) Assignee: ASAHI GLASS COMPANY, LIMITED, Chiyoda-ku (JP)

(21) Appl. No.: 13/015,155

(22) Filed: Jan. 27, 2011

(30) Foreign Application Priority Data
Feb. 2, 2010 (JP) 2010-021114

(51) Int. Cl. G11B 5/73; B24B 1/00

(52) U.S. Cl. 428/846.9; 451/37

(57) ABSTRACT

The present invention provides a method for lapping a glass substrate, including lapping a glass substrate having excellent maximum thickness deviation, and a method for manufacturing a glass substrate for a magnetic recording medium, including a step using the above-mentioned lapping method.

### FIELD OF THE INVENTION

The present invention relates to a method for lapping a glass substrate, comprising lapping both main surfaces of the glass substrate using a double side lapping machine, and a method for manufacturing a glass substrate for a magnetic recording medium, including a step using the above-mentioned lapping method.

### BACKGROUND OF THE INVENTION

With increasing high recording density of a magnetic disk in recent years, characteristics required to a glass substrate for a magnetic recording medium are becoming more severe year after year. To achieve high recording density of a magnetic disk, a magnetic head is attempted to pass up to the end of a glass substrate in order to effectively utilize an area of a main surface of the glass substrate. Furthermore, investigations are made to increase rotation speed of a magnetic disk in order to rapidly record a large volume of information in a magnetic disk and reproducing the information.

In the case of passing a magnetic head up to the end of a glass substrate or in the case of increasing rotation speed of a magnetic disk, if a glass substrate for a magnetic recording medium has turbulence in shape (such as maximum thickness deviation, flatness and the like), floating posture of the magnetic head is disturbed, and there is a possibility that the magnetic head contacts a magnetic recording medium, thereby causing a fault due to the contact. For this reason, severe requirements are becoming to be posed in a shape of a glass substrate for a magnetic recording medium, particularly dimensional specification such as maximum thickness deviation.

Production steps of a glass substrate for a magnetic recording medium generally include: a shape-forming step of forming a shape of a glass substrate; a lapping step of arranging a thickness of the glass substrate in a given thickness, thereby making flatness a given value; a polishing step of finishing both main surfaces of the glass substrate into a smooth mirror surface; and a cleaning step of removing contamination deposited to the surface of the glass substrate.

A free abrasive lapping method of lapping a glass substrate while supplying a lapping liquid containing free abrasives such as silicon carbide or alumina between the glass substrate and a platen, using a cast iron platen, and a fixed abrasive lapping method of fixing a fixed abrasive tool obtained by binding diamond abrasives with a metal, a resin or a glassy material (vitrified), followed by molding, to a surface of a platen and lapping a glass substrate with the fixed abrasive tool are known as the lapping step.

Before lapping the glass substrate by the above lapping method, dressing treatment is applied to a lapping surface of an upper platen of a double side lapping machine and a lapping surface of a lower platen thereof so as to form a given shape. The lapping surface of the upper platen and the lapping surface of the lower platen deviate from the given shape, it is difficult to uniformly apply processing pressure to a glass substrate to be lapped. As a result, a removal volume of the glass substrate varies, and it is difficult to arrange a thickness of the glass substrate lapped in a given thickness.

To obtain a lapping surface suitable for lapping the glass substrate, a method of correcting a lapping surface unevenly abraded is proposed (Patent Document 1).

However, Patent Document 1 has an object that the glass substrate is prevented from being broken during lapping. Therefore, difference in height of a shape of the lapping surface which laps the glass substrate is large, and uniformity of a thickness of the glass substrate lapped may not become the desired level.

Patent Document 1: JP-A-2008-824

### SUMMARY OF THE INVENTION

The present invention has an object to provide a method for lapping a glass substrate, comprising lapping a glass substrate having excellent maximum thickness deviation, and a method for manufacturing a glass substrate for a magnetic recording medium, including a step using the above-mentioned lapping method.

The present invention provides a method for manufacturing a glass substrate for a magnetic recording medium, the method comprising: a shape-forming step of performing shape forming to a glass substrate having a sheet shape; a lapping step of lapping a main surface of the glass substrate; a polishing step of polishing the main surface; and a cleaning step of cleaning the glass substrate, wherein the lapping step comprises: interposing a carrier holding the glass substrate having a sheet shape between a lapping surface of an upper platen of a double side lapping machine and a lapping surface of a lower platen thereof; and lapping both main surfaces of the glass substrate simultaneously by relatively moving the glass substrate and the lapping surfaces, while supplying a lapping liquid to the both main surfaces of the glass substrate in the state that the lapping surface of the upper platen and the lapping surface of the lower platen are pressed to the both main surfaces of the glass substrate, respectively, the upper platen and the lower platen have a disk shape having an inner peripheral edge and an outer peripheral edge, and shapes of the lapping surface of the upper platen and the lapping surface of the lower platen, of the double side lapping machine before lapping the glass substrate are shapes so that when a distance between the lapping surface of the upper platen and the lapping surface of the lower platen, at the inner peripheral edge is Din and a distance between the lapping surface of the upper platen and the lapping surface of the lower platen, at the outer peripheral edge is Dout, ΔD (=Dout−Din) obtained by subtracting Din from Dout is from −30 μm to +30 μm.

The method for lapping a glass substrate according to the present invention can manufacture a glass substrate having excellent uniformity of a thickness in high productivity by forming shapes of the lapping surface of the upper platen and the lapping surface of the lower platen, of a double side lapping machine before lapping the glass substrate into a given shape. The method for manufacturing a glass substrate for a magnetic recording medium, including a step using the lapping method of the present invention can provide a glass substrate for a magnetic recording medium, having excellent maximum thickness deviation. Therefore, in HDD test of a magnetic disk manufactured by forming a thin film such as a magnetic layer on the glass substrate for a magnetic recording medium, fault generated by the contact of a magnetic head with a magnetic recording medium can be reduced.

### BRIEF DESCRIPTION OF THE DRAWINGS

FIG. 1 is a perspective view of a glass substrate for a magnetic recording medium.

FIG. 2 is a schematic view of a double side lapping machine.

FIG. 3 is a schematic view showing shape measurement positions on a lapping surface of an upper platen and a lapping surface of a lower platen.

FIG. 4 is a cross-sectional view schematically showing a shape when shapes of a lapping surface of an upper platen and a lapping surface of a lower platen, of a double side lapping machine before lapping a glass substrate satisfy ΔD(=Dout−Din)>0.

FIG. 5 is a cross-sectional view schematically showing a shape when shapes of a lapping surface of an upper platen and a lapping surface of a lower platen, of a double side lapping machine before lapping a glass substrate satisfy ΔD(=Dout−Din)<0.

FIGS. 6A and 6B are measurement results (Examples) of shapes of a lapping surface of an upper platen and a lapping surface of a lower platen, of a double side lapping machine before lapping a glass substrate, in which FIG. 6A is the measurement results of a lapping surface of an upper platen, and FIG. 6B is the measurement results of a lapping surface of a lower platen.

FIGS. 7A and 7B are measurement results (Comparative Examples) of shapes of a lapping surface of an upper platen and a lapping surface of a lower platen, of a double side lapping machine before lapping a glass substrate, in which FIG. 7A is the measurement results of a lapping surface of an upper platen, and FIG. 7B is the measurement results of a lapping surface of a lower platen.

### DETAILED DESCRIPTION OF THE INVENTION

The present invention is described below by reference to the mode for carrying out the invention, but it should be understood that the invention is not construed as being limited to the following embodiments.

The manufacturing steps of a glass substrate for a magnetic recording medium and a magnetic disk generally include the following steps. (1) A glass sheet molded by a float process or a press molding process is processed into a click shape, and an inner peripheral side surface and an outer peripheral side surface are subjected to chamfering thereby obtaining a glass substrate. (2) Upper and lower main surfaces of the glass substrate are subjected to lapping. (3) The side surface part and the chamfered part of the glass substrate are subjected to edge polishing. (4) Upper and lower main surfaces of the glass substrate are subjected to polishing. The polishing step may be only primary polishing, may conduct the primary polishing and secondary polishing, and may conduct third polishing after the second polishing. (5) The glass substrate is subjected to precise cleaning, thereby manufacturing a glass substrate for a magnetic recording medium. (6) A thin film such as a magnetic layer is formed on the glass substrate for a magnetic recording medium, thereby manufacturing a magnetic disk.

In the above manufacturing steps of the glass substrate for a magnetic recording medium and the magnetic disk, glass substrate cleaning (in-process cleaning) and etching of a glass substrate surface (in-process etching) may be conducted between the respective steps. Furthermore, when a glass substrate for a magnetic recording medium is required to have high mechanical strength, a strengthening step (for example, chemical strengthening step) of forming a strengthening layer on the surface layer of the glass substrate may be conducted before the polishing step, after the polishing step or between the polishing steps.

In the present invention, the glass substrate for a magnetic recording medium may be an amorphous glass, a crystallized glass or a strengthened glass having a strengthening layer on the surface layer of the glass substrate (for example, a chemically strengthened glass). Furthermore, the glass sheet for the glass substrate of the present invention may be prepared by a float process or a press molding process.

The present invention relates to the step (2) of conducting lapping on upper and lower main surfaces of a glass substrate, and is concerned with the lapping of a glass substrate for a magnetic recording medium.

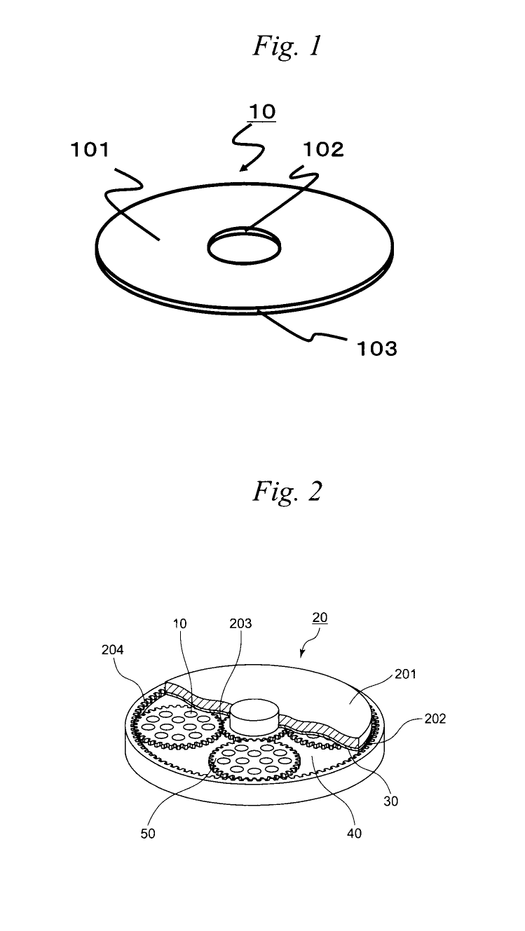

A perspective view of the glass substrate 10 for a magnetic recording medium according to the present invention is shown in FIG. 1, and a schematic view of a double side lapping machine 20 is shown in FIG. 2. In FIG. 1, 101 shows a main surface of a glass substrate for a magnetic recording medium, 102 shows an inner peripheral side surface, and 103 shows an outer peripheral side surface. In FIG. 2, 10 shows a glass substrate for a magnetic recording medium, 30 shows a lapping surface of an upper platen, 40 is a lapping surface of a lower platen, 50 shows a carrier, 201 shows an upper platen, 202 shows a lower platen, 203 shows a sun gear, and 204 shows an internal gear.

The glass substrate 10 for a magnetic recording medium is sandwiched between the lapping surface 30 of the upper platen and the lapping surface 40 of the lower platen in the state that the glass substrate is held on a glass substrate holding part of the carrier 50, a lapping liquid is supplied to both main surfaces of the glass substrate in the state that the lapping surface 30 of the upper platen and the lapping surface 40 of the lower platen are pressed to the both main surfaces of the glass substrate, respectively, and the glass substrate and the lapping surfaces are relatively moved, thereby simultaneously lapping the both main surfaces of the glass substrate.

The double side lapping machine 20 rotation-drives the sun gear 203 and the internal gear 204 at a given rotation ratio, respectively, thereby moving those so as to orbit the sun gear 203 while rotating the carrier 50, and rotation-drives the upper platen 201 and the lower platen 202 in a given rotation number, respectively, thereby lapping the glass substrate.

A fixed abrasive tool may not be provided on surfaces of the upper platen 201 and the lower platen 202, facing the glass substrate when a free abrasive lapping method is used, and is provided on the surfaces thereof when a fixed abrasive lapping method is used. When the fixed abrasive lapping method is used, a dressing treatment is applied to the fixed abrasive tools provided on the upper platen 201 and the lower platen 202 using a dressing jig in order to make the lapping surface 30 of the upper platen and the lapping surface 40 of the lower platen have a given shape, respectively. The dressing treatment is conducted by supplying dressing liquid between the dressing jig and the lapping surfaces 30 and 40, relatively moving the dressing jig and the lapping surfaces 30 and 40, and lapping the lapping surface of the fixed abrasive tool.

The shape of the lapping surface of the polishing pad having been subjected to the dressing treatment is measured with a straightness measuring device, a dial gauge, a straight gauge, a feeler gauge or the like. Measurement of the shape of the lapping surface with a straightness measuring device can be performed in the state that the upper platen 201 and the lower platen 202 are attached to the double side lapping machine.

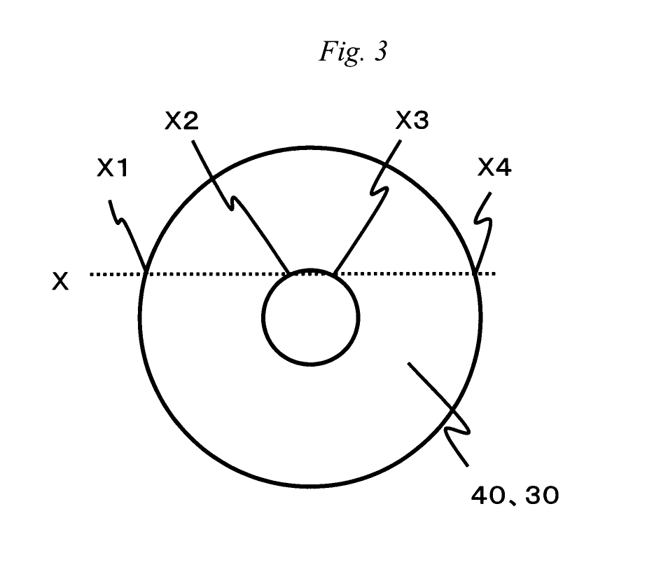

The shape measurement positions of the lapping surface 30 of the upper platen and the lapping surface 40 of the lower platen are shown in FIG. 3. The shape measurement is conducted by placing a straightness measuring device outside the outer periphery of the sun gear 203 such that a gauge head of the straightness measuring device passes inner peripheral edges (X2 and X3) and outer peripheral edges (X1 and X4) of the lapping surfaces 30 and 40.

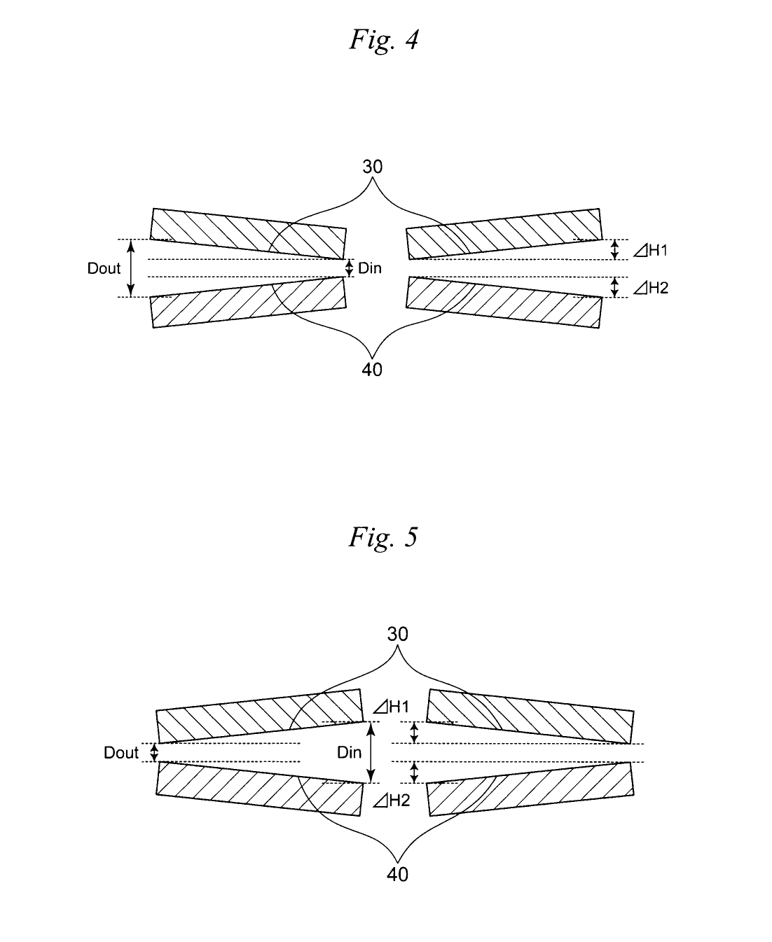

The cross-sectional views schematically showing the shapes of the lapping surface 30 of the upper platen and the lapping surface 40 of the lower platen before polishing the glass substrate are shown in FIGS. 4 and 5. In FIGS. 4 and 5, Din shows a distance between the lapping surface 30 of the upper platen and the lapping surface 40 of the lower platen at the inner peripheral edge, Dout shows a distance between the lapping surface 30 of the upper platen and the lapping surface 40 of the lower platen at the outer peripheral edge, ΔH1 shows the maximum difference in height of the lapping surface 30 of the upper platen, and ΔH2 shows the maximum difference in height of the lapping surface 40 of the lower platen.

FIG. 4 is a cross-sectional view schematically showing the shape of the lapping surface having ΔD(=Dout−Din)>0, and is a shape of the lapping surface in an inner contact state that the lapping surface 30 of the upper platen and the lapping surface 40 of the lower platen strongly contact to each other at the inner peripheral edge side. FIG. 5 is a cross-sectional view schematically showing the shape of the lapping surface having ΔD(=Dout−Din)<0, and is a shape of the lapping surface in an outer contact state that the lapping surface 30 of the upper platen and the lapping surface 40 of the lower platen strongly contact to each other at the outer peripheral edge side.

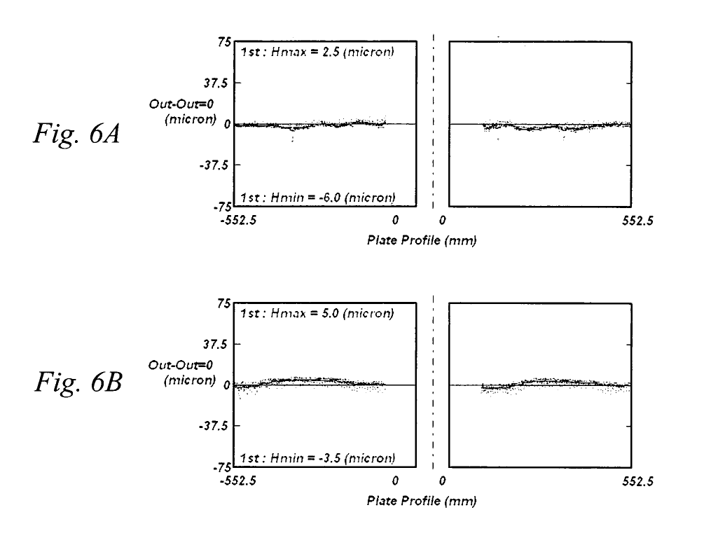

The measurement results of the shapes of the lapping surface 30 of the upper platen and the lapping surface 40 of the lower platen, measured using a straightness measuring device are shown in FIGS. 6A and 6B (Working Examples of the present invention). In FIG. 6, the profile FIG. 6A on the upper stage is the measurement results of the shape of the lapping surface 30 of the upper platen, and the profile FIG. 6B on the lower stage is the measurement results of the shape of the lapping surface 40 of the lower platen. The maximum height (Hmax) and the minimum height (Hmin) on the basis of the outer peripheral edges (X1 and X4) as a reference point are obtained from the shape measurement results of the lapping surfaces, and the maximum difference in height ΔH(=Hmax−Hmin) is calculated. When the inner peripheral edges (X2 and X3) are higher than the outer peripheral edges (X1 and X4), the maximum difference ΔH in height is shown by a plus value, and when the inner peripheral edges (X2 and X3) are lower than the outer peripheral edges (X1 and X4), the maximum difference ΔH in height is shown by a minus value.

When a distance between the lapping surface 30 of the upper platen and the lapping surface 40 of the lower platen at the inner peripheral edge is Din and a distance between the lapping surface 30 of the upper platen and the lapping surface 40 of the lower platen at the outer peripheral edge is Dout, ΔD(=Dout−Din) obtained by subtracting Din from Dout is obtained by subtracting the maximum difference ΔH1 in height of the lapping surface 30 of the upper platen from the maximum difference ΔH2 in height of the lapping surface 40 of the lower platen, and this leads to ΔD=Dout−Din=ΔH2−ΔH1.

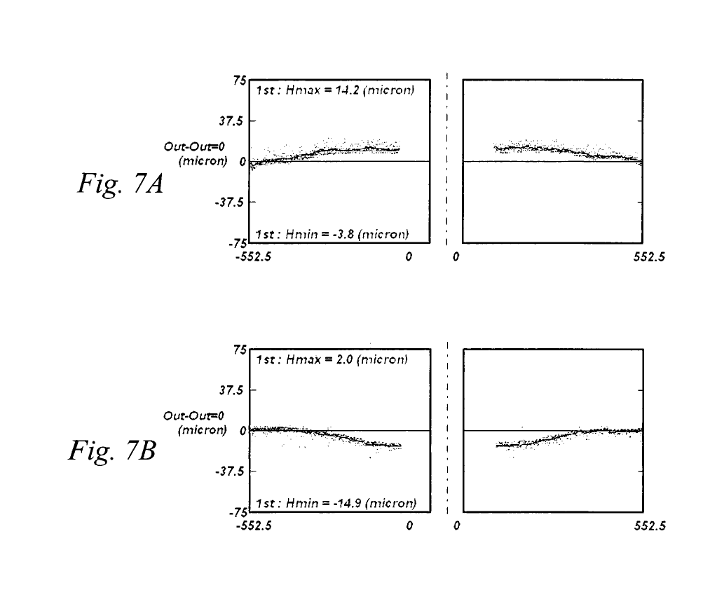

The shape measurement results of the lapping surface are further described below using FIGS. 6 and 7. In FIG. 6, the lapping surface 30 of the upper platen is that the maximum height (Hmax) is +2.5 μm and the minimum height (Hmin) is −6.0 μm. Therefore, the maximum difference in height ΔH1(=Hmax−Hmin) of the lapping surface 30 of the upper platen is +8.5 μm. The lapping surface 40 of the lower platen is that the maximum height (Hmax) is +5.0 μm and the minimum height (Hmin) is −3.5 μm. Therefore, the maximum difference in height ΔH2(=Hmax−Hmin) of the lapping surface 30 of the lower platen is +8.5 μm. Since ΔD(=Dout−Din=ΔH2−ΔH1) is 0 μm, the lapping surface of FIG. 6 has a shape that the lapping surface 30 of the upper platen and the lapping surface 40 of the lower platen contact to each other in flat state at the inner peripheral edge side.

In FIG. 7, the lapping surface 30 of the upper platen is that the maximum height (Hmax) is +14.2 μm and the minimum height (Hmin) is −3.8 μm. Therefore, the maximum difference in height ΔH1(=Hmax−Hmin) of the lapping surface 30 of the upper platen is +18.0 μm. The lapping surface 40 of the lower platen is that the maximum height (Hmax) is +2.0 μm and the minimum height (Hmin) is −14.9 μm. Therefore, the maximum difference in height ΔH2(=Hmax−Hmin) of the lapping surface 30 of the lower platen is −16.9 μm. Since ΔD(=Dout−Din=ΔH2−ΔH1) is −34.9 μm, the lapping surface of FIG. 7 has a lapping surface shape in an inner contact state that the lapping surface 30 of the upper platen and the lapping surface 40 of the lower platen strongly contact to each other at the outer peripheral edge side.

To obtain a glass substrate for a magnetic recording medium, having excellent maximum thickness deviation by lapping the glass substrate using the double side lapping machine 20, the shape ΔD(=Dout−Din) of the lapping surface 30 of the upper platen and the lapping surface 40 of the lower platen is from −30 μm to +30 μm.

When ΔD is less than −30 μm, the lapping surface 30 of the upper platen and the lapping surface 40 of the lower platen strongly contact to each other at the outer peripheral edge side, and furthermore, the peripheral speed of the glass substrate to be lapped is faster at the inner peripheral edge side than the outer peripheral edge side. Due to this, a removal volume of the glass substrate to be lapped is increased when the glass substrate passes the outer peripheral edge side of the lapping surface. As a result, a removal volume on the same glass substrate and/or a removal volume among glass substrates lapped in the same lot have variations, and it is difficult to obtain a glass substrate for a magnetic recording medium, having excellent maximum thickness deviation.

When ΔD exceeds +30 μm, the lapping surface 30 of the upper platen and the lapping surface 40 of the lower platen contact too strongly to each other at the inner peripheral edge side. This makes difficult to stably rotation-drive the upper platen 201 and the lower platen 202, and lapping pressure cannot uniformly be applied to the glass substrate. As a result, a removal volume of the glass substrate varies and it is difficult to obtain a glass substrate for a magnetic recording medium, having excellent maximum thickness deviation.

ΔD(=Dout−Din) is preferably from −25 μm to +25 μm, further preferably from −20 μm to +20 μm, and particularly preferably from −15 μm to +15 μm.

The dressing treatment is conducted by supplying dressing liquid between the dressing jig and the lapping surfaces 30 and 40, relatively moving the dressing jig and the lapping surfaces 30 and 40, and lapping the lapping surface of the fixed abrasive tool. The shapes of the lapping surface 30 of the upper platen and the lapping surface 40 of the lower platen can be formed in a given shape by controlling temperature difference ΔTpd (Tp−Td) between Td that is a temperature of the dressing liquid and Tp that is a temperature of the upper platen 201. Unless otherwise indicated, the upper platen 201 and the lower platen 202 are controlled to the same temperature.

When the Td that is a temperature of the dressing liquid is lower than the Tp that is a temperature of the upper platen 201 (ΔTpd>0), the upper platen 201 shrinks at the lapping surface side of the upper platen, and the lower platen 202 shrinks at the lapping surface side of the lower platen. Therefore, the shapes of the lapping surface 30 of the upper platen and the lapping surface 40 of the lower platen when conducting the dressing treatment are the lapping surface shape in an outer contact state (the shape shown in FIG. 5) that the lapping surface 30 of the upper platen and the lapping surface 40 of the lower platen strongly contact to each other at the outer peripheral edge side. When the dressing treatment is conducted in the outer contact state of the lapping surfaces, the outer peripheral edge side of the lapping surface is largely lapped. Therefore, after performing the dressing treatment, the shapes of the lapping surface 30 of the upper platen and the lapping surface 40 of the lower platen are formed into a lapping surface shape in an inner contact state (the shape shown in FIG. 4) that the lapping surface 30 of the upper platen and the lapping surface 40 of the lower platen strongly contact to each other at the inner peripheral edge side.

When the Td that is a temperature of the dressing liquid is higher than the Tp that is a temperature of the upper platen 201 (ΔTpd<0), the upper platen 201 expands at the lapping surface side of the upper platen, and the lower platen 202 expands at the lapping surface side of the lower platen. Therefore, the shapes of the lapping surface 30 of the upper platen and the lapping surface 40 of the lower platen when conducting the dressing treatment are the lapping surface shape in an inner contact state (the shape shown in FIG. 4) that the lapping surface 30 of the upper platen and the lapping surface 40 of the lower platen strongly contact to each other at the inner peripheral edge side. When the dressing treatment is conducted in the inner contact state of the lapping surfaces, the inner peripheral edge side of the lapping surfaces is largely lapped. Therefore, after performing the dressing treatment, the shapes of the lapping surface 30 of the upper platen and the lapping surface 40 of the lower platen are formed into a lapping surface shape in an outer contact state (the shape shown in FIG. 5) that the lapping surface 30 of the upper platen and the lapping surface 40 of the lower platen strongly contact to each other at the outer peripheral edge side.

To form the shapes of the lapping surface 30 of the upper platen and the lapping surface 40 of the lower platen such that ΔD (=Dout−Din) is from −30 μm to +30 82 m, ΔTpd (=Tp−Td) is preferably −7° C. to +2° C.

When the dressing treatment is conducted at ΔTpd (=Tp−Td) of less than −7° C. (for example, −10° C.,), the shapes of the lapping surface 30 of the upper platen and the lapping surface 40 of the lower platen become a lapping surface shape that ΔD (=Dout−Din) exceeds +30 μm. As a result, the lapping surface 30 of the upper platen and the lapping surface 40 of the lower platen contact too strongly to each other at the inner peripheral edge side. This makes difficult to stably rotation-drive the upper platen 201 and the lower platen 202, and lapping pressure cannot uniformly be applied to the glass substrate. As a result, a removal volume of the glass substrate varies and it is difficult to obtain a glass substrate for a magnetic recording medium, having excellent maximum thickness deviation.

When the dressing treatment is conducted in the state that ΔTpd (=Tp−Td) exceeds +2° C., the shapes of the lapping surface 30 of the upper platen and the lapping surface 40 of the lower platen become a lapping surface shape that ΔD (=Dout−Din) is less −30 μm. As a result, since the lapping surface 30 of the upper platen and the lapping surface 40 of the lower platen contact too strongly to each other at the outer peripheral edge side, lapping pressure to the glass substrate is increased at the outer peripheral edge side and peripheral speed of the glass substrate being polished becomes fast at the outer peripheral edge side as compared with the inner peripheral edge side. For those reasons, a removal volume is increased when the glass substrate for a magnetic recording medium to be lapped passes the outer peripheral edge side. As a result, a removal volume in the same glass substrate and/or a removal volume among the glass substrate lapped in the same lot vary, and it is difficult to obtain a glass substrate for a magnetic recording medium, having excellent maximum thickness deviation.

The temperature difference ΔTpd (=Tp−Td) between the Td that is a temperature of the dressing liquid and the Tp that is a temperature of the upper platen 201 is preferably from −7° C. to +2° C., and particularly preferably from −5° C. to +2° C.

The shapes of the lapping surface 30 of the upper platen and the lapping surface 40 of the lower platen are formed into the respective given shapes by the dressing treatment, and the lapping of the glass substrate is then conducted.

The glass substrate 10 for a magnetic recording medium is sandwiched between the lapping surface 30 of the upper platen and the lapping surface 40 of the lower platen in the state that the glass substrate is held on a glass substrate holding part of the carrier 50, and a lapping liquid is supplied to both main surfaces of the glass substrate in the state that the lapping surface 30 of the upper platen and the lapping surface 40 of the lower platen are pressed to the both main surfaces of the glass substrate, respectively. At the same time, the glass substrate and the lapping surfaces are relatively moved to simultaneously grind the both main surfaces of the glass substrate.

The shapes of the lapping surface 30 of the upper platen and the lapping surface 40 of the lower platen when the glass substrate is lapped can be controlled by adjusting a temperature difference ΔTcp (=Tc−Tp) between a Tc that is a temperature of the lapping liquid supplied to the both main surfaces of the glass substrate and the Tp that is a temperature of the upper platen 201.

When the Tc that is a temperature of the lapping liquid is lower than the Tp that is a temperature of the upper platen 201, the upper platen 201 shrinks at the lapping surface side of the upper platen, and the lower platen 202 shrinks at the lapping surface side of the lower platen. Therefore, the shapes of the lapping surface 30 of the upper platen and the lapping surface 40 of the lower platen during lapping the glass substrate is the lapping surface shape in an outer contact state (the shape shown in FIG. 5) that the lapping surface 30 of the upper platen and the lapping surface 40 of the lower platen strongly contact to each other at the outer peripheral edge side.

When the Tc that is a temperature of the lapping liquid is higher than the Tp that is a temperature of the upper platen 201, the upper platen 201 expands at the lapping surface side of the upper platen, and the lower platen 202 expands at the lapping surface side of the lower platen. Therefore, the shapes of the lapping surface 30 of the upper platen and the lapping surface 40 of the lower platen when the glass substrate is lapped become the lapping surface shape in an inner contact state (the shape shown in FIG. 4) that the lapping surface 30 of the upper platen and the lapping surface 40 of the lower platen strongly contact to each other at the inner peripheral edge side.

The temperature difference ΔTcp (=Tc−Tp) between the Tc that is a temperature of the lapping liquid supplied to the both main surfaces of the glass substrate and the Tp that is a temperature of the upper platen 201 is preferably from −2° C. to +8° C.

When the glass substrate is lapped at ΔTcp (=Tc−Tp) of less than −2° C. (for example, −6° C.), the lapping surface 30 of the upper platen and the lapping surface 40 of the lower platen contact too strongly to each other at the outer peripheral edge side. As a result, a removal volume of the substrate glass substrate is increased at the outer peripheral edge side of the lapping surface, and a removal volume in the same glass substrate and/or a removal volume among the glass substrates in the same lot vary, and it becomes difficult to obtain a glass substrate for a magnetic recording medium, having excellent maximum thickness deviation.

When the glass substrate is lapped in the state that ΔTcp (=Tc−Tp) exceeds +8° C., the lapping surface 30 of the upper platen and the lapping surface 40 of the lower platen contact too strongly to each other at the inner peripheral edge side. This makes difficult to stably rotation-drive the upper platen 201 and the lower platen 202, and lapping pressure cannot uniformly be applied to the glass substrate. As a result, a removal volume of the glass substrate varies and it becomes difficult to obtain a glass substrate for a magnetic recording medium, having excellent maximum thickness deviation in the same glass substrate.

The temperature difference ΔTcp (=Tc−Tp) between the Tc that is a temperature of the lapping liquid supplied to the both main surfaces of the glass substrate and the Tp that is a temperature of the upper platen 201 is preferably from −2° C. to +8° C., further preferably from 2° C. to +6° C., and particularly preferably from −1° C. to +4° C.

The present invention can be applied to both a lapping method using free abrasives and a lapping method using a fixed abrasive tool. The lapping method using a fixed abrasive tool is that a fixed abrasive tool obtained by binding diamond abrasives with a metal, a resin or a vitreous material and molding the same is fixed to a surface of a platen of a lapping machine, and a glass substrate is lapped by the fixed abrasive tool. The method obtains high lapping speed originated from hardness of diamond, and is therefore particularly preferably used.

The fixed abrasive tool obtained by binding diamond abrasives with a metal, a resin or a vitreous material and molding the same is that diamond abrasives are exposed on the lapping surface of the fixed abrasive tool. It is preferable that the fixed abrasive tool comprises a plate-shaped resin member or a plate-shaped metal member and diamond abrasives exposed thereon. The diamond abrasives preferably have an average particle diameter (hereinafter referred to as an “average particle size”) of from 0.5 to 45 μm. When the average particle size of the diamond abrasives is less than 0.5 μm, speed of lapping a glass substrate is decreased, and productivity may be deteriorated. When the average particle size of the diamond abrasives exceeds 45 μm, deep scratches (processing modified layer) are formed on the surface of the glass substrate when lapping the glass substrate. As a result, the scratches (processing modified layer) are not sufficiently removed by the subsequent polishing step, and may remain as defects on both main surfaces of a glass substrate for a magnetic recording medium. Furthermore, the surface of the glass substrate lapped is roughly finished. As a result, a removal volume must be set in a large amount in the subsequent polishing step, and this may lead to deterioration of productivity of the overall production steps of a glass substrate for a magnetic recording medium. The average particle size of the diamond abrasives is preferably from 0.5 to 45 μm, and particularly preferably from 1 to 40 μm.

A glass substrate for a magnetic recording medium is required to have severe level of thickness characteristics and flatness characteristics as compared with those required in other glass substrate products. A method for manufacturing a glass substrate for a magnetic recording medium, including the present lapping method and a step using the present lapping method is most preferably applied to such a glass substrate for a magnetic recording medium.

In the present invention, a thickness of a disk-shaped glass substrate having a circular hole at the center thereof is measured using a micrometer or a mass method. When the maximum thickness deviation in the same glass substrate is evaluated, the thickness is measured using a micrometer.

A thickness is measured at eight positions in total of 0°, 90°, 180° and 270° in an inner diameter side region and an outer diameter side region of a recording and reproducing region of a glass substrate for a magnetic recording substrate, and the maximum thickness deviation (=maximum thickness−minimum thickness) in the same glass substrate and the maximum thickness deviation (=maximum thickness−minimum thickness) among the glass substrates lapped in the same lot are evaluated. The number of glass substrates used for the measurement of a thickness is not particularly limited. For example, when one hundred glass substrates are simultaneously lapped using 16B double side lapping machine, five to ten glass substrates are extracted from one lot, and a thickness thereof is measured.

When a thickness is measured at eight positions in total of 0°, 90°, 180° and 270° in an inner diameter side region and an outer diameter side region of a recording and reproducing region of a glass substrate for a magnetic recording substrate, and the maximum thickness deviation in the same glass substrate is evaluated, the maximum thickness deviation in the same glass substrate is generally 3 μm or less, preferably 2 μm or less, further preferably 1 μm or less, and particularly preferably 0.5 μm or less. Furthermore, the maximum thickness deviation among the glass substrates lapped in the same lot is generally 4 μm or less, preferably 3 μm or less, further preferably 2 μm or less, and particularly preferably 1 μm or less.

When a thickness of the glass substrate for a magnetic recording medium manufactured by a method for manufacturing a glass substrate for a magnetic recording medium, including a step of the present lapping method is measured at eight positions in total of 0°, 90°, 180° and 270° in an inner diameter side region and an outer diameter side region of a recording and reproducing region, and the maximum thickness deviation in the same glass substrate is measured, the maximum thickness deviation in the same glass substrate is preferably 1 μm or less, further preferably 0.5 μm or less, and particularly preferably 0.3 μm or less. Furthermore, the maximum thickness deviation among the glass substrates lapped in the same lot is preferably 2 μm or less, further preferably 1 μm or less, and particularly preferably 0.5 μm or less.

In HDD test results of a magnetic disk manufactured by forming a thin film such as a magnetic layer on a glass substrate for a magnetic recording medium, when the maximum thickness deviation in the same glass substrate exceeds 3 μm, floating posture of a magnetic head is disturbed, and the magnetic head contacts a magnetic recording medium, leading to generation of fault. Floating posture of the magnetic head is stabilized with decreasing the maximum thickness deviation in the same glass substrate.

### EXAMPLES

The present invention is further described below by reference to the following Examples and Comparative Examples, but it should be understood that the invention is not construed as being limited thereto.

### Forming Shape to Glass Substrate for Magnetic Recording Medium

A glass substrate comprising SiO₂ as a main component and being molded by a float process was processed into a doughnut-shaped circular glass substrate (a disk-shaped glass substrate having a circular hole at the center thereof) for the purpose of obtaining a glass substrate for a magnetic recording medium having an outer diameter of 65 mm, an inner diameter of 20 mm and a thickness of 0.635 mm.

The inner peripheral side surface and the outer peripheral side surface of the doughnut-shaped circular glass substrate were subjected to chamfering so as to obtain a glass substrate for a magnetic recording medium having a chamfering width of 0.15 mm and a chamfering angle of 45°.

### Edge Polishing of Glass Substrate for Magnetic Recording Medium

The inner peripheral side surface and the inner peripheral chamfered part were polished with a polishing brush and cerium oxide abrasives to remove scratches on the inner peripheral side surface and the inner peripheral chamfered part, and the inner peripheral edge was polished so as to obtain mirror surface. The glass substrate after polishing the inner peripheral edge was subjected to scrub cleaning with an alkaline detergent and ultrasonic cleaning in the state of dipping the glass substrate in the alkaline detergent, thereby removing the abrasives.

The outer peripheral side surface and the outer peripheral chamfered part of the glass substrate after polishing the inner peripheral edge were polished with a polishing brush and cerium oxide abrasives to remove scratches on the outer peripheral side surface and the outer peripheral chamfered part, and the outer peripheral edge was polished so as to obtain mirror surface. The glass substrate after polishing the outer peripheral edge was subjected to scrub cleaning with an alkaline detergent and ultrasonic cleaning in the state of dipping the glass substrate in the alkaline detergent, thereby removing the abrasives.

### Lapping of Glass Substrate for Magnetic Recording Medium

Upper and lower main surfaces were subjected to primary lapping by a double side lapping machine (product name: 16BF-4M5P, manufactured by Hamai Co., Ltd.) using a cast iron platen as a polishing tool and a lapping liquid containing alumina abrasives. The glass substrate lapped was cleaned to remove abrasives, and then subjected to secondary lapping.

The secondary lapping was conducted as follows. Upper and lower main surface of the glass substrate were lapped by a double side lapping machine (product name: 16BF-4M5P, manufactured by Hamai Co., Ltd.) using a fixed abrasive tool (product name: Trizact 9 μm, AA1, manufactured by 3M) as a polishing tool and a lapping liquid. The secondary lapping of the glass substrate was conducted such that main lapping pressure is 100 g/cm², rotation number of a platen is 30 rpm, and a lapping time is set such that a thickness of the glass substrate lapped becomes the preset thickness. The lapping of the glass substrate was conducted by driving an upper platen in a counterclockwise rotation direction, driving a lower platen in a clockwise direction and driving a sun gear and an internal gear such that a carrier rotates in a counterclockwise rotation direction. The glass substrate after lapping was cleaned, and the maximum thickness deviation thereof was measured.

The fixed abrasive tools attached to an upper platen and a lower platen of the double side lapping machine were subjected to a dressing treatment using a dressing jig before lapping the glass substrate, and formed into a given lapping shape. The shape of the lapping surface of the fixed abrasive tool having been subjected to the dressing treatment was measured with a straightness measuring device (product name: HSS-1700, manufactured by Hitz Hi-Technology). Shapes of the lapping surfaces of the upper platen and the lower platen were measured by that the straightness measuring device is placed along line X shown in FIG. 3 and a gauge head of the straightness measuring device passes outer peripheral edges (X1 and X4) and inner peripheral edges (X2 and X3). The maximum difference in height ΔH1 of the lapping surface of the upper platen, the maximum difference in height ΔH2 of the lapping surface of the lower platen, and ΔD (=4H2−4H1=Dout−Din) were obtained from the measurement results by the straightness measuring device of the lapping surface of the fixed abrasive tool (before lapping the glass substrate) having been subjected to the dressing treatment.

Thickness of the glass substrate having been subjected to the secondary lapping was measured with a micrometer (product name: MDC-MJ/JP, manufactured by Mitsutoyo Corporation). Thickness of the glass substrate was measured at eight positions of 0°, 90°, 180° and 270° in 15 mm (inner diameter side region of a recording and reproducing region) from the center and 27 mm (outer diameter side region of a recording and reproducing region) from the center. The maximum thickness deviation in the same glass substrate was obtained from the difference between the maximum thickness and the minimum thickness in thicknesses. The thickness was measured by extracting five glass substrates per one lot (one hundred glass substrates). The maximum thickness deviation among glass substrates lapped in the same lot was obtained from the difference between the maximum thickness and the minimum thickness in thicknesses (forty thicknesses in total) obtained by measuring five glass substrates.

Lapping surfaces of fixed abrasive tools fixed to the upper platen and the lower platen of the double side lapping machine were subjected to a dressing treatment at Tp that is a temperature of the upper platen of 22° C. and a Td that is a temperature of dressing liquid of 20° C. using a dressing tool comprising a ring-shaped white alumina. The results obtained by measuring the thus-obtained shapes of the lapping surfaces of the fixed abrasive tools are shown in FIG. 6. The shape of the lapping surface that ΔD is 0 μm could be obtained by conducting the dressing treatment at ΔTpd of +2° C.

Ten lots of glass substrates were lapped using a double side lapping machine having the shape of the lapping surface shown in FIG. 6, having been subjected to the dressing treatment. Thickness measurement results of the glass substrate lapped at the Tp that is a temperature of the upper platen of 22° C. and the Tc that is a temperature of the lapping liquid of 25° C., the maximum thickness deviation in the same glass substrate, and the maximum thickness deviation in the same lot are shown in Table 1 (Examples). In all of lots, the maximum thickness deviation of the glass substrates in the same glass substrate is 1.0 μm or less, and the maximum thickness deviation lapped in the same lot is 2.0 μm or less. Thus, a glass substrate having excellent maximum thickness deviation could be obtained.

As shown in FIG. 7, the shape ΔD of the lapping surfaces of the fixed abrasive tools fixed to the upper platen and the lower platen of the double side lapping machine was set to −34.9 μm, and ten lots of glass substrates were lapped. The measurement results of the maximum thickness deviation of the glass substrates lapped are shown in Table 2 (Comparative Examples). When the shape ΔD of the lapping surface is set to −34.9 μm and the glass substrate is lapped, there are some glass substrates in which the maximum thickness deviation in the same glass substrate exceeds 3.0 μm, and some lots in which the maximum thickness deviation of the glass substrates lapped in the same lot exceeds 4.0 μm. Thus, it became difficult to stably obtain a glass substrate having excellent maximum thickness deviation.

### Polishing of Glass Substrate for Magnetic Recording Medium

Upper and lower main surfaces of the glass substrate were subjected to primary polishing by a double side lapping machine using a hard urethane polishing pad as a polishing tool, and a polishing slurry containing cerium oxide abrasives (a polishing slurry composition comprising cerium oxide having an average particle diameter (hereinafter referred to as an “average particle size”) of about 1.1 μm as a main component). The glass substrate after the polishing was cleaned to remove cerium oxide, and the maximum thickness deviation in the same glass substrate was measured.

Upper and lower main surfaces of the glass substrate after the primary polishing were polished with a double side lapping machine using a soft urethane pad as a polishing tool, and a polishing slurry containing cerium oxide abrasives having an average particle size smaller than that of the cerium oxide abrasives used in the primary polishing (a polishing slurry composition comprising cerium oxide having an average particle size of about 0.5 μm as a main component). The glass substrate thus treated was cleaned to remove cerium oxide.

The glass substrate after the above secondary polishing is then subjected to final polishing (tertiary polishing). Upper and lower main surfaces of the glass substrate after the secondary polishing were polished with a double side lapping machine using a soft urethane polishing pad as a polishing tool for the finish polishing (tertiary polishing) and a polishing slurry containing colloidal silica (a polishing slurry composition comprising colloidal silica having an average particle size of primary particles of from 20 to 30 nm as a main component).

### Cleaning of Glass Substrate for Magnetic Recording Medium

The glass substrate after the tertiary polishing was dipped in a solution having pH adjusted to the same pH of the polishing slurry for the finish polishing, and then successively subjected to scrub cleaning with an alkaline detergent, ultrasonic cleaning in the state that the glass substrate is dipped in an alkaline detergent solution, and ultrasonic cleaning in the state that the glass substrate is dipped in pure water. The glass substrate thus treated was dried with vapor of isopropyl alcohol.

After cleaning and drying the glass substrate, the maximum thickness deviation of a glass substrate for a magnetic recording medium was measured. The maximum thickness deviation of the glass substrate for a magnetic recording medium was measured with a micrometer in the same method as in the glass substrate after lapping. The maximum thickness deviation in the same glass substrate of the glass substrate for a magnetic recording medium was 1 μm or less, and the maximum thickness deviation among the glass substrates lapped in the same lot was 2 μm or less.

TABLE 1

| | | | | Glass substrate No. | | | | | | | | | |
|---|---|---|---|---|---|---|---|---|---|---|---|---|---|
| | | | | 1 | | 2 | | 3 | | 4 | | 5 | |
| | | | | Measurement position of glass substrate | | | | | | | | | |
| | | | | Outer | Inner | Outer | Inner | Outer | Inner | Outer | Inner | Outer | Inner |
| | | | | diam- | diam- | diam- | diam- | diam- | diam- | diam- | diam- | diam- | diam- |
| | | | | eter | eter | eter | eter | eter | eter | eter | eter | eter | eter |
| | Lot. | | | side | side | side | side | side | side | side | side | side | side |
| | No. | | | region | region | region | region | region | region | region | region | region | region |
| Ex. 1 | 1 | Thickness (μm) of glass substrate | 0° | 849 | 849 | 848 | 848 | 848 | 848 | 848 | 848 | 848 | 848 |
| | | | 90° | 849 | 849 | 848 | 848 | 848 | 848 | 848 | 848 | 848 | 848 |
| | | | 180° | 849 | 848 | 848 | 848 | 848 | 848 | 848 | 848 | 848 | 848 |
| | | | 270° | 849 | 848 | 848 | 848 | 848 | 848 | 848 | 848 | 848 | 848 |
| | | Maximum thickness deviation in same | | 1.0 | | 0.0 | | 0.0 | | 0.0 | | 0.0 | |
| | | glass substrate (μm) | | | | | | | | | | | |
| | | Maximum thickness deviation in same | | 1.0 | | | | | | | | | |
| | | lot (μm) | | | | | | | | | | | |
| Ex. 2 | 2 | Thickness (μm) of glass substrate | 0° | 849 | 849 | 849 | 849 | 849 | 848 | 849 | 849 | 848 | 848 |
| | | | 90° | 849 | 849 | 849 | 849 | 849 | 848 | 849 | 849 | 848 | 848 |
| | | | 180° | 849 | 849 | 849 | 849 | 849 | 848 | 849 | 849 | 848 | 848 |
| | | | 270° | 849 | 849 | 849 | 849 | 849 | 848 | 849 | 849 | 848 | 848 |
| | | Maximum thickness deviation in same | | 0.0 | | 0.0 | | 1.0 | | 0.0 | | 0.0 | |
| | | glass substrate (μm) | | | | | | | | | | | |
| | | Maximum thickness deviation in same | | 1.0 | | | | | | | | | |
| | | lot (μm) | | | | | | | | | | | |
| Ex. 3 | 3 | Thickness (μm) of glass substrate | 0° | 849 | 849 | 850 | 850 | 850 | 849 | 850 | 850 | 850 | 850 |
| | | | 90° | 850 | 849 | 850 | 850 | 850 | 850 | 850 | 850 | 850 | 850 |
| | | | 180° | 850 | 849 | 850 | 850 | 850 | 850 | 850 | 850 | 850 | 850 |
| | | | 270° | 849 | 849 | 850 | 850 | 850 | 850 | 850 | 850 | 850 | 850 |
| | | Maximum thickness deviation in same | | 1.0 | | 0.0 | | 1.0 | | 0.0 | | 0.0 | |
| | | glass substrate (μm) | | | | | | | | | | | |
| | | Maximum thickness deviation in same | | 1.0 | | | | | | | | | |
| | | lot (μm) | | | | | | | | | | | |
| Ex. 4 | 4 | Thickness (μm) of glass substrate | 0° | 848 | 848 | 849 | 849 | 848 | 849 | 849 | 849 | 849 | 849 |
| | | | 90° | 849 | 848 | 849 | 849 | 848 | 849 | 849 | 849 | 849 | 849 |
| | | | 180° | 848 | 848 | 849 | 849 | 849 | 849 | 849 | 849 | 849 | 849 |
| | | | 270° | 848 | 848 | 849 | 849 | 849 | 849 | 849 | 849 | 849 | 849 |
| | | Maximum thickness deviation in same | | 1.0 | | 0.0 | | 1.0 | | 0.0 | | 0.0 | |
| | | glass substrate (μm) | | | | | | | | | | | |
| | | Maximum thickness deviation in same | | 1.0 | | | | | | | | | |
| | | lot (μm) | | | | | | | | | | | |
| Ex. 5 | 5 | Thickness (μm) of glass substrate | 0° | 850 | 850 | 849 | 849 | 849 | 849 | 849 | 849 | 849 | 849 |
| | | | 90° | 850 | 850 | 849 | 849 | 849 | 849 | 849 | 849 | 849 | 849 |
| | | | 180° | 850 | 849 | 849 | 849 | 849 | 849 | 849 | 849 | 849 | 849 |
| | | | 270° | 850 | 849 | 849 | 849 | 849 | 849 | 849 | 849 | 849 | 849 |
| | | Maximum thickness deviation in same | | 1.0 | | 0.0 | | 0.0 | | 0.0 | | 0.0 | |
| | | glass substrate (μm) | | | | | | | | | | | |
| | | Maximum thickness deviation in same | | 1.0 | | | | | | | | | |
| | | lot (μm) | | | | | | | | | | | |
| Ex. 6 | 6 | Thickness (μm) of glass substrate | 0° | 850 | 850 | 850 | 850 | 850 | 850 | 850 | 850 | 850 | 850 |
| | | | 90° | 850 | 850 | 851 | 850 | 850 | 851 | 850 | 850 | 850 | 850 |
| | | | 180° | 850 | 850 | 851 | 851 | 850 | 850 | 850 | 850 | 850 | 850 |
| | | | 270° | 850 | 850 | 851 | 851 | 850 | 850 | 851 | 850 | 850 | 850 |
| | | Maximum thickness deviation in same | | 0.0 | | 1.0 | | 1.0 | | 1.0 | | 0.0 | |
| | | glass substrate (μm) | | | | | | | | | | | |
| | | Maximum thickness deviation in same | | 1.0 | | | | | | | | | |
| | | lot (μm) | | | | | | | | | | | |
| Ex. 7 | 7 | Thickness (μm) of glass substrate | 0° | 847 | 847 | 847 | 848 | 847 | 848 | 848 | 848 | 848 | 847 |
| | | | 90° | 847 | 847 | 848 | 847 | 847 | 847 | 847 | 848 | 847 | 847 |
| | | | 180° | 847 | 847 | 847 | 848 | 848 | 848 | 848 | 848 | 847 | 847 |
| | | | 270° | 847 | 847 | 848 | 848 | 848 | 848 | 847 | 848 | 847 | 847 |
| | | Maximum thickness deviation in same | | 0.0 | | 1.0 | | 1.0 | | 1.0 | | 1.0 | |
| | | glass substrate (μm) | | | | | | | | | | | |
| | | Maximum thickness deviation in same | | 1.0 | | | | | | | | | |
| | | lot (μm) | | | | | | | | | | | |
| Ex. 8 | 8 | Thickness (μm) of glass substrate | 0° | 849 | 849 | 850 | 850 | 850 | 850 | 850 | 849 | 849 | 849 |
| | | | 90° | 850 | 850 | 850 | 850 | 850 | 850 | 850 | 850 | 849 | 849 |
| | | | 180° | 850 | 850 | 850 | 850 | 850 | 850 | 850 | 850 | 849 | 849 |
| | | | 270° | 850 | 850 | 850 | 850 | 850 | 850 | 850 | 850 | 849 | 849 |
| | | Maximum thickness deviation in same | | 1.0 | | 0.0 | | 0.0 | | 1.0 | | 0.0 | |
| | | glass substrate (μm) | | | | | | | | | | | |
| | | Maximum thickness deviation in same | | 1.0 | | | | | | | | | |
| | | lot (μm) | | | | | | | | | | | |
| Ex. 9 | 9 | Thickness (μm) of glass substrate | 0° | 848 | 849 | 849 | 849 | 849 | 849 | 849 | 849 | 848 | 848 |
| | | | 90° | 849 | 849 | 849 | 849 | 849 | 849 | 849 | 848 | 848 | 848 |
| | | | 180° | 849 | 849 | 849 | 849 | 849 | 849 | 849 | 849 | 848 | 848 |
| | | | 270° | 848 | 848 | 849 | 849 | 849 | 848 | 849 | 849 | 848 | 848 |
| | | Maximum thickness deviation in same | | 1.0 | | 0.0 | | 1.0 | | 1.0 | | 0.0 | |
| | | glass substrate (μm) | | | | | | | | | | | |
| | | Maximum thickness deviation in same | | 1.0 | | | | | | | | | |
| | | lot (μm) | | | | | | | | | | | |
| Ex. 10 | 10 | Thickness (μm) of glass substrate | 0° | 847 | 847 | 848 | 848 | 848 | 848 | 848 | 848 | 848 | 848 |
| | | | 90° | 848 | 847 | 848 | 848 | 848 | 847 | 848 | 848 | 848 | 848 |
| | | | 180° | 848 | 847 | 848 | 848 | 848 | 847 | 848 | 848 | 848 | 848 |
| | | | 270° | 847 | 847 | 848 | 848 | 848 | 847 | 848 | 848 | 848 | 848 |

| Maximum thickness deviation in same | 1.0 | 0.0 | 1.0 | 0.0 | 0.0 |
|---|---|---|---|---|---|
| glass substrate (μm) | | | | | |

| | |
|---|---|
| Maximum thickness deviation in same | 1.0 |
| lot (μm) | |

TABLE 2

| | | | | Glass substrate No. | | | | | | | | | |
|---|---|---|---|---|---|---|---|---|---|---|---|---|---|
| | | | | 1 | | 2 | | 3 | | 4 | | 5 | |
| | | | | Measurement position of glass substrate | | | | | | | | | |
| | | | | Outer | Inner | Outer | Inner | Outer | Inner | Outer | Inner | Outer | Inner |
| | | | | diam- | diam- | diam- | diam- | diam- | diam- | diam- | diam- | diam- | diam- |
| | | | | eter | eter | eter | eter | eter | eter | eter | eter | eter | eter |
| | Lot | | | side | side | side | side | side | side | side | side | side | side |
| | No. | | | region | region | region | region | region | region | region | region | region | region |
| Ex. 11 | 1 | Thickness (μm) of glass substrate | 0° | 684 | 683 | 686 | 686 | 683 | 683 | 686 | 685 | 685 | 685 |
| | | | 90° | 683 | 682 | 686 | 687 | 683 | 682 | 687 | 687 | 686 | 685 |
| | | | 180° | 680 | 681 | 686 | 686 | 683 | 683 | 686 | 685 | 684 | 685 |
| | | | 270° | 684 | 684 | 686 | 687 | 683 | 683 | 685 | 686 | 685 | 686 |
| | | Maximum thickness deviation in same | | 4.0 | | 1.0 | | 1.0 | | 2.0 | | 2.0 | |
| | | glass substrate (μm) | | | | | | | | | | | |
| | | Maximum thickness deviation in same | | 7.0 | | | | | | | | | |
| | | lot (μm) | | | | | | | | | | | |
| Ex. 12 | 2 | Thickness (μm) of glass substrate | 0° | 683 | 683 | 686 | 685 | 684 | 683 | 684 | 685 | 683 | 683 |
| | | | 90° | 682 | 683 | 686 | 685 | 683 | 682 | 684 | 684 | 683 | 684 |
| | | | 180° | 685 | 684 | 685 | 685 | 682 | 682 | 685 | 684 | 683 | 684 |
| | | | 270° | 683 | 683 | 686 | 686 | 683 | 683 | 684 | 684 | 684 | 683 |
| | | Maximum thickness deviation in same | | 3.0 | | 1.0 | | 2.0 | | 1.0 | | 1.0 | |
| | | glass substrate (μm) | | | | | | | | | | | |
| | | Maximum thickness deviation in same | | 4.0 | | | | | | | | | |
| | | lot (μm) | | | | | | | | | | | |
| Ex. 13 | 3 | Thickness (μm) of glass substrate | 0° | 678 | 677 | 680 | 680 | 678 | 678 | 679 | 679 | 677 | 678 |
| | | | 90° | 678 | 678 | 680 | 681 | 677 | 677 | 679 | 680 | 675 | 676 |
| | | | 180° | 679 | 678 | 681 | 681 | 678 | 677 | 680 | 679 | 678 | 677 |
| | | | 270° | 677 | 677 | 679 | 680 | 678 | 678 | 679 | 680 | 678 | 678 |
| | | Maximum thickness deviation in same | | 2.0 | | 2.0 | | 1.0 | | 1.0 | | 3.0 | |
| | | glass substrate (μm) | | | | | | | | | | | |
| | | Maximum thickness deviation in same | | 6.0 | | | | | | | | | |
| | | lot (μm) | | | | | | | | | | | |
| Ex. 14 | 4 | Thickness (μm) of glass substrate | 0° | 681 | 681 | 684 | 683 | 681 | 680 | 685 | 684 | 682 | 682 |
| | | | 90° | 682 | 681 | 683 | 684 | 681 | 680 | 683 | 683 | 681 | 681 |
| | | | 180° | 682 | 682 | 683 | 683 | 680 | 681 | 683 | 684 | 681 | 680 |
| | | | 270° | 682 | 682 | 683 | 683 | 683 | 682 | 683 | 684 | 680 | 680 |
| | | Maximum thickness deviation in same | | 1.0 | | 1.0 | | 3.0 | | 2.0 | | 2.0 | |
| | | glass substrate (μm) | | | | | | | | | | | |
| | | Maximum thickness deviation in same | | 5.0 | | | | | | | | | |
| | | lot (μm) | | | | | | | | | | | |
| Ex. 15 | 5 | Thickness (μm) of glass substrate | 0° | 679 | 680 | 682 | 681 | 681 | 680 | 681 | 681 | 681 | 680 |
| | | | 90° | 680 | 680 | 681 | 681 | 681 | 680 | 681 | 681 | 682 | 681 |
| | | | 180° | 680 | 679 | 681 | 682 | 680 | 681 | 680 | 681 | 680 | 680 |
| | | | 270° | 679 | 679 | 683 | 682 | 680 | 681 | 680 | 681 | 682 | 681 |
| | | Maximum thickness deviation in same | | 1.0 | | 2.0 | | 1.0 | | 1.0 | | 2.0 | |
| | | glass substrate (μm) | | | | | | | | | | | |
| | | Maximum thickness deviation in same | | 4.0 | | | | | | | | | |
| | | lot (μm) | | | | | | | | | | | |
| Ex. 16 | 6 | Thickness (μm) of glass substrate | 0° | 694 | 693 | 695 | 694 | 693 | 693 | 693 | 693 | 692 | 692 |
| | | | 90° | 693 | 693 | 694 | 693 | 694 | 694 | 692 | 693 | 692 | 692 |
| | | | 180° | 693 | 693 | 695 | 694 | 693 | 694 | 692 | 693 | 692 | 692 |
| | | | 270° | 694 | 693 | 693 | 694 | 693 | 694 | 692 | 693 | 692 | 692 |
| | | Maximum thickness deviation in same | | 1.0 | | 2.0 | | 1.0 | | 1.0 | | 0.0 | |
| | | glass substrate (μm) | | | | | | | | | | | |
| | | Maximum thickness deviation in same | | 3.0 | | | | | | | | | |
| | | lot (μm) | | | | | | | | | | | |
| Ex. 17 | 7 | Thickness (μm) of glass substrate | 0° | 681 | 680 | 682 | 682 | 680 | 680 | 680 | 681 | 680 | 680 |
| | | | 90° | 680 | 681 | 682 | 682 | 681 | 681 | 681 | 681 | 680 | 680 |
| | | | 180° | 680 | 681 | 682 | 682 | 681 | 681 | 681 | 681 | 679 | 680 |
| | | | 270° | 681 | 680 | 682 | 682 | 681 | 681 | 681 | 681 | 680 | 680 |
| | | Maximum thickness deviation in same | | 1.0 | | 0.0 | | 1.0 | | 1.0 | | 1.0 | |
| | | glass substrate (μm) | | | | | | | | | | | |
| | | Maximum thickness deviation in same | | 3.0 | | | | | | | | | |
| | | lot (μm) | | | | | | | | | | | |
| Ex. 18 | 8 | Thickness (μm) of glass substrate | 0° | 708 | 708 | 710 | 710 | 710 | 709 | 709 | 709 | 708 | 708 |
| | | | 90° | 708 | 708 | 709 | 710 | 709 | 709 | 709 | 709 | 708 | 708 |
| | | | 180° | 708 | 708 | 710 | 709 | 709 | 709 | 710 | 709 | 707 | 708 |
| | | | 270° | 708 | 708 | 709 | 710 | 709 | 709 | 709 | 709 | 708 | 708 |
| | | Maximum thickness deviation in same | | 0.0 | | 1.0 | | 1.0 | | 1.0 | | 1.0 | |
| | | glass substrate (μm) | | | | | | | | | | | |
| | | Maximum thickness deviation in same | | 3.0 | | | | | | | | | |
| | | lot (μm) | | | | | | | | | | | |
| Ex. 19 | 9 | Thickness (μm) of glass substrate | 0° | 663 | 663 | 663 | 663 | 663 | 663 | 664 | 663 | 663 | 663 |
| | | | 90° | 663 | 663 | 663 | 663 | 663 | 663 | 663 | 664 | 663 | 663 |
| | | | 180° | 663 | 663 | 663 | 663 | 663 | 663 | 663 | 663 | 662 | 663 |
| | | | 270° | 663 | 663 | 664 | 663 | 664 | 663 | 663 | 663 | 663 | 663 |
| | | Maximum thickness deviation in same | | 0.0 | | 1.0 | | 1.0 | | 1.0 | | 1.0 | |
| | | glass substrate (μm) | | | | | | | | | | | |
| | | Maximum thickness deviation in same | | 2.0 | | | | | | | | | |
| | | lot (μm) | | | | | | | | | | | |
| Ex. 20 | 10 | Thickness (μm) of glass substrate | 0° | 636 | 635 | 636 | 636 | 635 | 635 | 636 | 635 | 635 | 635 |
| | | | 90° | 636 | 635 | 636 | 636 | 635 | 635 | 635 | 635 | 635 | 636 |
| | | | 180° | 635 | 635 | 636 | 636 | 635 | 635 | 635 | 635 | 635 | 635 |
| | | | 270° | 635 | 635 | 637 | 636 | 636 | 635 | 636 | 635 | 636 | 635 |

| Maximum thickness deviation in same | 1.0 | 1.0 | 1.0 | 1.0 | 1.0 |
|---|---|---|---|---|---|
| glass substrate (μm) | | | | | |
| Maximum thickness deviation in same | 2.0 | | | | |
| lot (μm) | | | | | |

While the invention has been described in detail with reference to specific embodiments thereof, it will be apparent to one skilled in the art that various changes and modifications can be made therein without departing from the spirit and scope thereof.

Incidentally, the present application is based on Japanese Patent Applications No. 2010-021114 filed on Feb. 2, 2010, and the contents are incorporated herein by reference.

Also, all the references cited herein are incorporated as a whole.

The present invention can be applied to a method for manufacturing a glass substrate, including a lapping step of a glass substrate having a sheet shape. As the glass substrate having a sheet shape, glass substrates for a magnetic recording medium, for a photomask, and for a display such as liquid crystal or organic EL may be specifically mentioned.

### DESCRIPTION OF REFERENCE NUMERALS AND SIGNS

10: Glass substrate for magnetic recording medium

101: Main surface of glass substrate for magnetic recording medium

102: Inner peripheral side surface

103: Outer peripheral side surface

20: Double side lapping machine

30: Lapping surface of upper platen

40: Lapping surface of lower platen

50: Carrier

201: Upper platen

202: Lower platen

203: Sun gear

204: Internal gear

X: Shape measurement position of lapping surface

X2, X3: Inner peripheral edges of lapping surfaces 30, 40

X1, X4: Outer peripheral edges of lapping surfaces 30, 40

Din: Distance between lapping surface 30 of upper platen and lapping surface 40 of lower platen, at inner peripheral edge

Dout: Distance between lapping surface 30 of upper platen and lapping surface 40 of lower platen, at outer peripheral edge

ΔH1: Maximum difference in height of lapping surface 30 of upper platen

ΔH2: Maximum difference in height of lapping surface 40 of lower platen

What is claimed is:

1. A method for manufacturing a glass substrate for a magnetic recording medium, said method comprising: a shape-forming step of performing shape forming to a glass substrate having a sheet shape; a lapping step of lapping a main surface of the glass substrate; a polishing step of polishing said main surface; and a cleaning step of cleaning the glass substrate,
wherein the lapping step comprises:
interposing a carrier holding the glass substrate having a sheet shape between a lapping surface of an upper platen of a double side lapping machine and a lapping surface of a lower platen thereof; and
lapping both main surfaces of the glass substrate simultaneously by relatively moving the glass substrate and the lapping surfaces, while supplying a lapping liquid to the both main surfaces of the glass substrate in the state that the lapping surface of the upper platen and the lapping surface of the lower platen are pressed to the both main surfaces of the glass substrate, respectively,
the upper platen and the lower platen have a disk shape having an inner peripheral edge and an outer peripheral edge, and
shapes of the lapping surface of the upper platen and the lapping surface of the lower platen, of the double side lapping machine before lapping the glass substrate are shapes so that when a distance between the lapping surface of the upper platen and the lapping surface of the lower platen, at the inner peripheral edge is Din and a distance between the lapping surface of the upper platen and the lapping surface of the lower platen, at the outer peripheral edge is Dout, ΔD (=Dout−Din) obtained by subtracting Din from Dout is from −30 μm to +30 μm.

2. The method for manufacturing a glass substrate for a magnetic recording medium according to claim 1, wherein the lapping step comprises a dressing treatment step of forming shapes of the lapping surface of the upper platen and the lapping surface of the lower platen, and a dressing liquid used in the dressing treatment step has Td that is a temperature in which ΔTpd (=Tp−Td) obtained by subtracting Td from Tp that is a temperature of the upper platen is from −7° C. to +2° C.

3. The method for manufacturing a glass substrate for a magnetic recording medium according to claim 1, wherein in the lapping step, the lapping liquid has Tc that is a temperature in which ΔTcp (=Tc−Tp) obtained by subtracting Tc from Tp that is a temperature of the upper platen is from −2° C. to +8° C.

4. The method for manufacturing a glass substrate for a magnetic recording medium according to claim 1, wherein the lapping is conducted using a fixed abrasive tool, and the fixed abrasive tool is placed on the lapping surface of the upper platen and the lapping surface of the lower platen, respectively.

5. The method for manufacturing a glass substrate for a magnetic recording medium according to claim 4, wherein the fixed abrasive tool comprises a plate-shaped resin member or a plate-shaped metal member and diamond abrasives exposed thereon.

6. The method for manufacturing a glass substrate for a magnetic recording medium according to claim 5, wherein the diamond abrasives have an average particle diameter of from 0.5 to 45 μm.

7. A glass substrate for a magnetic recording medium, having a circular hole at the center thereof manufactured by the method for manufacturing a glass substrate for a magnetic recording medium according to claim 1, which is a disk-shaped glass substrate having a circular hole at the center thereof, said glass substrate being lapped so that a maximum thickness deviation in the same glass substrate is 3 μm or less.

8. The glass substrate for a magnetic recording medium, having a circular hole at the center thereof according to claim 7, wherein said maximum thickness deviation in the same glass substrate is 1 μm or less.

9. The glass substrate for a magnetic recording medium, having a circular hole at the center thereof according to claim 7, which is lapped with a maximum thickness deviation among glass substrates lapped in the same lot of 4 μm or less.

10. The glass substrate for a magnetic recording medium, having a circular hole at the center thereof according to claim 8, having a maximum thickness deviation among glass substrates lapped in the same lot of 2 μm or less.
